(19) United States
(12) Patent Application Publication
(10) Pub. No.: US 2008/0290981 A1
(43) Pub. Date: Nov. 27, 2008

(54) Fixing Apparatus for an Electrical Winding

(75) Inventors: Joachim Bischoff, Esslingen (DE); Karl-Heinz Charwat, Weilheim (DE); Rudolf Hanov, Weilheim (DE); Peter Olschewski, Schorndorf (DE); Richard Sille, Kirchheim (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/095,437

(22) PCT Filed: Nov. 20, 2006
(86) PCT No.: PCT/EP2006/068667

§ 371 Date: Jun. 16, 2008

(30) Foreign Application Priority Data
Nov. 29, 2005 (DE) 10 2005 058 119.6

(51) Int. Cl. H01F 27/30

(52) U.S. Cl. 336/208

(57) ABSTRACT

An electrical winding can be arranged concentrically around a magnet core. A novel transformer includes at least one magnet core and at least one electrical winding, wherein the electrical winding can be arranged concentrically around the magnet core. The electrical windings are connected fixedly to a fixing apparatus, wherein the fixing apparatus can be fixed in a radial plane. As a result, subsequent fixing of the electrical windings in relation to one another and in relation to the magnet core which is to be reinforced mechanically is dispensed with.

The invention relates to an electrical winding, it being possible for the electrical winding to be arranged concentrically around a magnet core.

The invention likewise relates to a transformer which comprises at least one magnet core and at least one electrical winding, it being possible for the electrical winding to be arranged concentrically around the magnet core.

When constructing electromagnetic components such as inductors or transformers, precise arrangement, fixing and mechanical stabilization of the individual assembly elements in relation to one another is required. The relative position of the magnet core to the windings needs to be ensured at any time during production, transport and during operation, which sometimes lasts for decades.

In the case of cast resin transformers, the lower-voltage and/or upper-voltage windings are cast using a casting resin compound and ensure mechanical stability of the thus produced cast resin bodies. A corresponding cast resin transformer is conventionally constructed such that the magnet core, in particular in the case of multiple-limb magnet cores, is used with clamping frames arranged on the upper and lower side to mechanically stabilize the magnet cores, which are usually produced from layers of individual laminates. In accordance with the prior art, the inner winding—usually the lower-voltage winding—is fixed in relation to the magnet core by distancing elements and by supporting apparatuses arranged on the lower side and possibly on the upper side. The outer winding is likewise fixed in relation to the inner winding by means of supporting apparatuses and possibly with the aid of distancing elements. The magnet core is in this case mechanically reinforced by outer supporting frames, such as peripheral binding, for example, and acts as a support for the outer electrical windings by means of the distancing elements.

In order to ensure that the windings are fixed in relation to the magnet core even when the transformer is transported, a clamping frame is conventionally arranged on the magnet core outer surface, which clamping frame provides for bracing between the windings and the clamping frame by means of corresponding supporting apparatuses. The supporting apparatus firstly serves the purpose of electrically insulating the windings from the ground potential of the clamping frame and of the magnet core and secondly serves the purpose of assisting in fixing the inner winding in relation to the magnet core, which is mechanically reinforced by the outer supporting frame, this relative fixing being carried out by means of distancing elements.

However, one disadvantage here is the fact that the prestress of the relative fixing of the inner winding in relation to the magnet core needs to be set precisely. In particular during transport, it is to be expected, owing to the sometimes high accelerations of the transformer, that the wedge elements used can become detached owing to transport if the prestress of the wedge elements is set incorrectly and therefore the fixing is lost. In addition, when restraining using elastomers or springs, these elastomers or springs need to take the thermal expansion over the life of the transformer.

One object of the present invention is to avoid the abovementioned disadvantages of the prior art and to implement simple fixing of the windings.

The object is achieved by the characterizing features of patent claims 1 and 6. The object is achieved according to the features of claim 1 by virtue of the fact that the electrical winding is fixedly connected to a fixing apparatus, which is arranged on at least one front side of the electrical winding and can be fixed on a radial plane. Owing to the integration of the fixing apparatus in the construction of the electrical winding, it is not necessary to use bracing and distancing elements in relation to an outer holder and/or to a magnet core reinforced by supporting frames. The electrical winding is fixed on a radial plane by means of the fixing apparatus which is fixedly connected to the electrical winding, the electrical winding being arranged concentrically around the magnet core. Readjustment or relative fixing between the magnet core and the outer electrical windings is not required when fixing on the radial plane since the magnet core is likewise fixed in relation to a radial plane by the surrounding clamping frame.

In contrast to known supporting apparatuses for fixing the electrical windings in relation to the magnet core, in accordance with the present invention no further holding or wedging element is required for subsequently adjusting and fixing the assembly elements. Depending on the manner selected for fastening on the radial plane, no relative movement between the fixing apparatus and the electrical winding occurs owing to the fact that the fixing apparatus is integrated in the electrical winding, with the result that external influences, such as accelerations during transport of the transformer, for example, cannot move the electrical winding, which is fastened by means of the fixing apparatus.

One advantageous refinement of the invention provides for the fixing apparatus to be cast with the electrical winding to form a cast resin winding by means of casting resin. The cast resin winding thus produced has a high degree of inherent mechanical stability and at the same time ensures a fixed connection between the fixing apparatus and the electrical winding. According to the invention, provision is in this case made for a plurality of fixing apparatuses to be arranged equidistantly on the circumference of the electrical winding on the lower front side. As a result, the mechanical loading of the cast resin winding is further minimized and sufficient contact faces are made available on the radial plane for connecting the respective fixing apparatuses to an outer holder.

The fixing apparatus advantageously has a receptacle for fastening means. In the simplest case, this may be a threaded hole in that side of the fixing apparatus which is remote from the front side, it being possible for a corresponding fastening means, such as a screw, for example, to be screwed into said threaded hole and therefore for the cast resin winding to be permanently fixed to a corresponding outer holder.

In one advantageous refinement of the present invention, the fixing apparatus is fastened to the outer holder by means of at least one compensation element for compensating for a radial movement of the cast resin winding. Owing to the usually different materials used for the windings and the outer clamping frame, in the event of thermal loading owing to the different coefficients of thermal expansion, different material expansions result and therefore relative displacements between the cast resin winding and the outer holder result. Owing to these potential relative displacements of the cast resin windings in relation to the outer holder, this may lead, in the case of a rigid connection between the fixing apparatus and the outer holder and in the case of a high thermal load, to breakage of the fixing apparatus. Owing to the use of compensation elements, such as, for example, a slot which is aligned radially in relation to each fixing apparatus and compensates for the expansions (brought about during operation) of the cast resin winding in relation to the outer holder, these relative displacements are compensated for. Elastic compensation elements can likewise compensate for the relative displacements occurring owing to the different coefficients of thermal expansion of the cast resin winding and the outer holder. The compensation elements are in this case either integrated directly in the fixing apparatus and/or the outer holder and/or are arranged as connecting elements between the fixing apparatus and the outer holder. The combination of the abovementioned solutions of a compensation element integrated in the fixing apparatus with a compensation element as (at the same time) a connecting element between the fixing apparatus and the outer holder also represents an advantageous refinement of the present invention. The same applies to the combination of a compensation element integrated in the outer holder in conjunction with a compensation element as a connecting element between the fixing apparatus and the outer holder.

The object is likewise achieved by the characterizing features of patent claim 6. The transformer according to the invention is characterized by the fact that the electrical winding is fixedly connected to a fixing apparatus, which is arranged on at least one front side of the electrical winding, and this fixing apparatus can be connected in relation to the magnet core based on a radial plane. This radial plane may be, for example, the lower clamping frame as the outer holder.

The invention provides for the electrical winding to be cast with the fixing apparatus to form a cast resin winding by means of a casting resin. The cast resin winding thus produced, when arranged around the transformer core, acts as the lower-voltage winding and/or as the upper-voltage winding. These cast resin windings according to the invention make it possible to form the lower-voltage winding and/or the upper-voltage winding as the cast resin winding and for it no longer to be necessary for said windings to be fixed in relation to a magnet core reinforced by supporting frames. Owing to the fixing to an outer holder and, at the same time, the high mechanical stability of the thus formed cast resin windings as the lower-voltage and/or upper-voltage windings, it is no longer necessary for there to be fixing by means of distancing elements and a magnet core reinforced by supporting frames in accordance with the conventional manufacturing method. In accordance with the present invention, it is instead possible to dispense with the conventionally used supporting frame of the magnet core and to transfer the stability of the cast resin windings according to the invention to the inner magnet core, without supporting frames, by means of distancing elements and therefore to fix the magnet core without additional auxiliary means.

In one advantageous refinement, the fixing apparatus and/or the outer holder and/or a connecting element between the fixing apparatus and the outer holder are equipped with at least one compensation element for accepting radial displacements of the cast resin winding. Firstly, this may be a radially aligned slot-like cutout within the outer holder or the fixing apparatus. Elastic compensation elements can likewise also be arranged between the outer holder and the fixing apparatus as connecting elements.

Advantageously, the electrical winding, as the lower-voltage winding, is not designed as a completely compound-filled cast resin winding and is fixed in relation to the magnet core. The upper-voltage winding, as the cast resin winding, is arranged around the lower-voltage winding and the magnet core and is fastened to the outer holder, such as the lower clamping frame, for example, by means of the fixing apparatus.

The invention likewise provides for the upper clamping frame, as the upper yoke of the transformer cores, to be only slightly wider than the width of the magnet core and therefore not to impair the circulation of a cooling medium, such as air or oil, for example, between the inner winding and the magnet core. As a result of the fact that no bent-back clamping frames are used according to the invention above the electrical winding, cooling of the transformer is no longer impaired. Since no supporting elements are used in the interspaces between the magnet core and the lower-voltage winding and/or the lower-voltage winding and the upper-voltage winding, unimpeded air circulation is provided between these electrical components. Without a bent-back upper clamping frame above the electrical windings for the purpose of bracing the windings in the axial direction, this conventional form of the upper clamping frame can be replaced by a clamping frame which is not bent back. As a result, the air then circulates between the upper-voltage winding and the lower-voltage winding and between the magnet core and the lower-voltage winding in an unimpeded manner, which ensures increased throughput of the ambient air between the windings. This results in markedly improved cooling of the windings with, at the same time, reduced use of materials for the outer clamping frame.

Further features according to the invention are given in the dependent claims. The invention will be explained in more detail with reference to the figures below, in which:

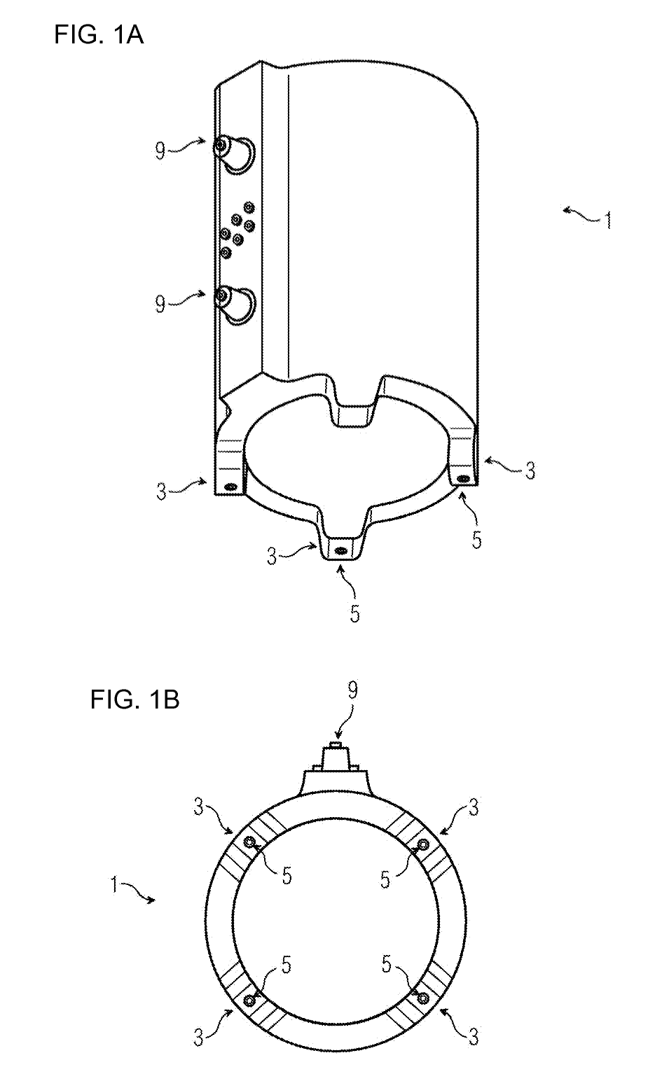

FIG. 1a shows a schematic side view of the cast resin winding having four fixing apparatuses each having a receptacle for a fastening element;

FIG. 1b shows a schematic view from below of the cast resin winding having four fixing apparatuses each having a receptacle for a fastening element;

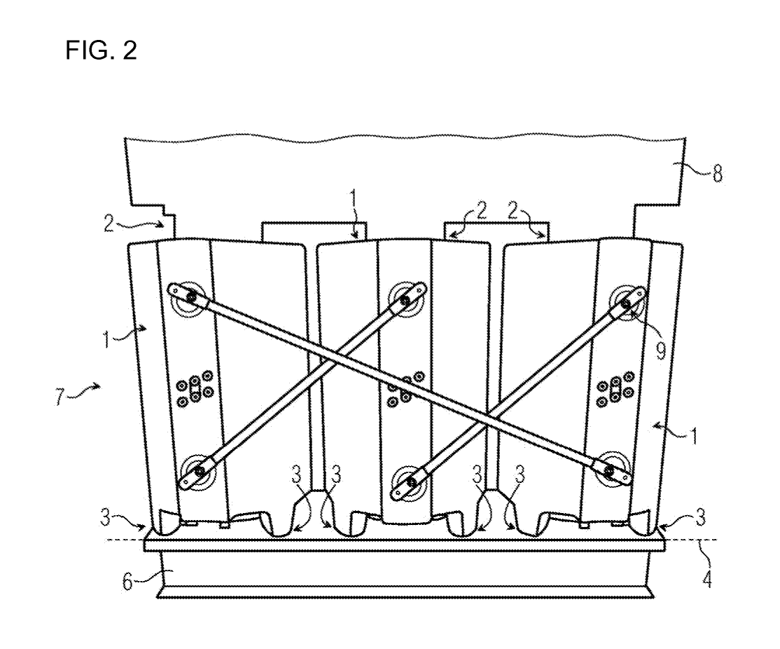

FIG. 2 shows a schematic side view of the transformer according to the invention in a three-limb magnet core embodiment.

FIG. 1a shows a schematic side view of the cast resin winding 1 having four fixing apparatuses 3 each having a receptacle for a fastening element 5. The cast resin winding 1 likewise shows the upper-voltage terminals 9 in the schematic side view. Owing to the fact that the fixing apparatuses 3 are completely integrated in the cast resin winding 1 to form a cast resin body which is cast jointly, firstly a stable form of the cast resin body is provided. Secondly, the integration of the fixing apparatuses 3 in the cast resin winding 1 ensures that the cast resin winding 1 can be fixed exclusively by means of the fixing apparatuses 3 and a corresponding radial plane 4 (not illustrated).

FIG. 1b shows a schematic view from below of the cast resin winding 1 having four fixing apparatuses 3 each having a receptacle for a fastening element 5. The radial plane 4 is located precisely in the plane of the drawing. This cast resin winding 1 can be turned over a transformer core 2 (not illustrated) owing to the inner cutouts and connected on a radial plane 4, such as the lower clamping frame 6.

A completely open interspace remains between the transformer core 2 and a cast resin winding 1 used as the lower-voltage winding. Fixing of the cast resin winding 1 by means of distancing elements to a magnet core 2 stabilized by a supporting frame, which has until now been necessary, is therefore no longer required with the present invention.

FIG. 2 shows a transformer 7 according to the invention in a three-limb magnet core embodiment. In this case, the lower clamping frame 6 forms the radial plane 4. The electrical winding as the lower-voltage winding and the cast resin winding as the upper-voltage winding rest on this radial plane 4 and are only fixed by means of this connection. The concentric cooling channel formed between the lower-voltage winding and the upper-voltage winding in this case is not reduced by any wedging elements. In order to achieve further improved cooling of the thus created transformer 7, the clamping frame 8 is designed to have parts which are not bent back, in the upper region of the transformer. The conventional bent-back portions of the clamping frame 8 for axially fixing the magnet core 2 are no longer required for the abovementioned transformer 7 according to the invention and can therefore be omitted. This apparatus according to the invention therefore provides for improved cooling of the entire transformer 7.

1-12. (canceled)

13. An electrical winding assembly, comprising:
an electrical winding configured to be concentrically arranged around a magnet core, said electrical winding having a front side;
a fixing apparatus fixedly connected to said electrical winding on at least one front side of said electrical winding; and
said fixing apparatus being configured to be affixed on a radial plane.

14. The electrical winding assembly according to claim 13, wherein said fixing apparatus and said electrical winding are cast together to form a cast resin winding.

15. The electrical winding assembly according to claim 14, wherein said fixing apparatus are a plurality of fixing apparatus distributed equidistantly over a circumference of said electrical winding on the front side of said cast resin winding.

16. The electrical winding assembly according to claim 13, wherein said fixing apparatus are a plurality of fixing apparatus distributed equidistantly over a circumference of said electrical winding on the front side of said electrical winding.

17. The electrical winding assembly according to claim 13, wherein said fixing apparatus has a receptacle for fastening means.

18. The electrical winding assembly according to claim 13, which further comprises at least one compensation element, and said at least one compensation element is disposed in said fixing apparatus, and/or in an outer holder of the assembly, and/or between said fixing apparatus and said outer holder.

19. A transformer, comprising:
at least one magnet core;
at least one electrical winding configured to be concentrically arranged about said magnet core, said electrical winding having a front side;
a fixing apparatus fixedly connected to said electrical winding on at least one front side of said electrical winding; and
said fixing apparatus being configured to be affixed on a radial plane.

20. The transformer according to claim 19, wherein said fixing apparatus and said electrical winding are cast together to form a cast resin winding.

21. The transformer according to claim 20, wherein said cast resin winding around said transformer core is configured to act as at least one of a lower-voltage winding and an upper-voltage winding.

22. The transformer according to claim 20, wherein said magnet core is formed with one or more limbs, and said cast resin winding is fastened, by way of said fixing apparatus, onto a lower clamping frame forming an outer holder.

23. The transformer according to claim 19, which further comprises at least one compensation element, and said at least one compensation element is disposed in said fixing apparatus, and/or in an outer holder of the assembly, and/or between said fixing apparatus and said outer holder.

24. The transformer according to claim 19, wherein a lower-voltage winding formed by said electrical winding is disposed around said magnet core, and a cast resin winding, forming an upper-voltage winding, is disposed around said lower-voltage winding and said magnet core, and wherein said electrical winding and said cast resin winding are fixed to an outer holder by way of said fixing apparatus.

25. The transformer according to claim 19, which comprises an upper clamping frame forming an upper yoke of the transformer, said upper clamping frame having a width only slightly wider than a width of said magnet core by an amount to not impair a circulation of a cooling medium between an inner winding and said magnet core.
